(19) United States
(12) Patent Application Publication
(10) Pub. No.: US 2023/0184073 A1
(43) Pub. Date: Jun. 15, 2023

(54) RESERVOIR SIMULATION BASED ON CAPACITANCE-RESISTANCE MODELING FOR HYDROCARBON EXPLORATION

(71) Applicant: Saudi Arabian Oil Company, Dhahran (SA)

(72) Inventors: Cenk Temizel, Dhahran (SA); Hasan O. Yildiz, Dhahran (SA)

(21) Appl. No.: 17/643,993

(22) Filed: Dec. 13, 2021

(51) Int. Cl. E21B 43/20; E21B 49/08; G01V 99/00

(52) U.S. Cl. CPC E21B 43/20; E21B 49/088; E21B 49/0875; G01V 99/005; E21B 2200/22; E21B 2200/20

(57) ABSTRACT

Methods and systems for predicting oil production from a reservoir are configured for obtaining production data from a hydrocarbon reservoir, the production data comprising data representing a fractional oil flow; determining, based on the production data, a relationship between the fractional oil flow and cumulative liquid production; identifying, based on the relationship between the fractional oil flow and cumulative liquid production, a post-water breakthrough point; estimating a value for a group parameter at a reference point of the relationship occurring after the post-water breakthrough point; and based on the value of the group parameter, generating a prediction of a future fractional oil flow and a future rate of production of oil from the hydrocarbon reservoir.

### TECHNICAL FIELD

The present disclosure generally relates to an approach for reservoir simulation for hydrocarbon exploration and extraction.

### BACKGROUND

Reservoir simulation can be performed for forecasting production performance at a waterflood reservoir. Production performance can be performed for reservoir management, as well as for operational optimization. Reservoir simulation can include full three dimensional (3D) finite difference or streamline models. In addition, capacitance-resistance modeling (CRM) can be performed for simulation. CRM is based on calibration of historical injection and/or production data, and is therefore efficient for field operational and surveillance applications. CRM is efficient relative to 3D finite difference models, which rely on a relatively detailed geological description and a relatively lengthy history matching process that at times is difficult to obtain.

CRM modeling models the waterflood in a reservoir. CRM models develop correlations between rates of injection and amounts of liquid production. Liquid production rate can be history-matched and predicted using the CRM method because of a strong voidage relationship between injection and production for a mature waterflood process.

Production of oil can be forecasted by a CRM model by multiplying an amount of liquid production with a function of the amount of oil cut. The estimation is performed through fitting of historical production and injection data using the cumulative injection based empirical oil fractional flow models or the saturation-based oil fractional flow model.

### SUMMARY

This disclosure describes systems and methods for predicting production of hydrocarbons (such as oil) from a reservoir using CRM models that rely on analytical models rather than empirical data. The analytical models include a modeled wettability of the reservoir using a contact angle that can be calculated rather than measured. Specifically, to generate the model, the data processing system replaces an array of empirical models with a Y-function model for oil flow. The data processing system determines a historical performance of production for injected water breakthrough timing. The data processing system determines various operational parameter values such as water channeling and an impact of pattern reconfiguration events like infill drilling, recompletion and other field redevelopment measures. The data processing system determines, from these data, a group parameter for oil production. The data processing system determines wettability in situ based on oil production rates and oil volumes.

The described implementations can provide various technical benefits. The data processing system can estimate production rate without requiring a detailed geological description or performing relatively lengthy history matching process. The analytical process improves production forecast. For example, the data processing system determines the oil rate from the gross rate. The data processing system is capable of predicting oil rate at different wettability conditions also introduced. The data processing system predicts production rates without accessing empirical models that introduce uncertainty from curve-fitting and regression models for oil fractional flow to information collected regarding the production in the field.

The following implementations each enable one or more of the foregoing technical advantages.

In a general aspect, a process for predicting oil production from a reservoir includes obtaining production data from a hydrocarbon reservoir, the production data comprising data representing a fractional oil flow; determining, based on the production data, a relationship between the fractional oil flow and cumulative liquid production; identifying, based on the relationship between the fractional oil flow and cumulative liquid production, a post-water breakthrough point; estimating a value for a group parameter at a reference point of the relationship occurring after the post-water breakthrough point; and based on the value of the group parameter, generating a prediction of a future fractional oil flow and a future rate of production of oil from the hydrocarbon reservoir.

In some implementations, the production data comprises values for at least one of pore volume of the hydrocarbon reservoir and a volumetric sweep efficiency of the hydrocarbon reservoir.

In some implementations, the relationship between the fractional oil flow and cumulative liquid production comprises an analytical equation

$$Y = {f}_{o} ( 1 - {f}_{o} ) = ( \frac{{E}_{V}}{B} PV ) \frac{1}{{Q}_{L}} ,$$

wherein Y is the relationship, fₒ is the fractional oil flow, Eᵥ is a value of volumetric sweep efficiency for the hydrocarbon reservoir, PV is a value of a pore volume of the hydrocarbon reservoir, B is a ratio of a relative permeability of oil to a relative permeability of water, and Q_{L} is a value of the cumulative liquid production in the hydrocarbon reservoir.

In some implementations, estimating a value for a group parameter (Ev/B)*PV at a reference point of the relationship comprises determining the value for the group parameter by setting Y=fₒ (1−fₒ)=0, wherein Y is the relationship, fₒ is the fractional oil flow, Eᵥ is a value of volumetric sweep efficiency for the hydrocarbon reservoir, PV is a value of a pore volume of the hydrocarbon reservoir, B is a ratio of a relative permeability of oil to a relative permeability of water.

In some implementations, the process includes drilling a well in the hydrocarbon reservoir based on the prediction of the future fractional oil flow or the future rate of production of oil from the hydrocarbon reservoir.

In some implementations, generating the prediction of a future fractional oil flow and a future rate of production of oil from the hydrocarbon reservoir comprises applying a capacitance-resistance model (CRM) to the relationship between the fractional oil flow and cumulative liquid production, the CRM configured to determine a value for a capillary pressure based on the predicted fractional flow of oil.

In a general aspect, a system for predicting oil production from a reservoir includes at least one processor; and a memory storing instructions that, when executed by the at least one processor, cause the at least one processor to perform operations including obtaining production data from a hydrocarbon reservoir, the production data comprising data representing a fractional oil flow; determining, based on the production data, a relationship between the fractional oil flow and cumulative liquid production; identifying, based on the relationship between the fractional oil flow and cumulative liquid production, a post-water breakthrough point; estimating a value for a group parameter at a reference point of the relationship occurring after the post-water breakthrough point; and based on the value of the group parameter, generating a prediction of a future fractional oil flow and a future rate of production of oil from the hydrocarbon reservoir.

In a general aspect, one or more non-transitory computer readable media store instructions for predicting oil production from a reservoir. The instructions, when executed by at least one processor, are configured to cause the at least one processor to perform operations including obtaining production data from a hydrocarbon reservoir, the production data comprising data representing a fractional oil flow; determining, based on the production data, a relationship between the fractional oil flow and cumulative liquid production; identifying, based on the relationship between the fractional oil flow and cumulative liquid production, a post-water breakthrough point; estimating a value for a group parameter at a reference point of the relationship occurring after the post-water breakthrough point; and based on the value of the group parameter, generating a prediction of a future fractional oil flow and a future rate of production of oil from the hydrocarbon reservoir.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 is a schematic view of a seismic survey being performed to map subterranean features such as facies and faults.

FIG. 2 is a flow diagram illustrating a process for predicting production of hydrocarbons from a reservoir using analytical CRM models.

FIG. 3 shows an example data processing system for predicting production of hydrocarbons from a reservoir using analytical CRM models.

FIG. 4 shows an example of a Y-function for predicting production of hydrocarbons from a reservoir.

FIG. 5 is an illustration of example data showing a production history from the reservoir of FIG. 4.

FIG. 6 is an illustration of example data showing a comparison of oil-rate predictions from the reservoir of FIGS. 4-6.

FIG. 7 is an illustration of example data showing production performance diagnosis by the Y-function method for the reservoir of FIGS. 4-6.

FIG. 8 is an illustration of example data showing an oil-cut calculation comparison for the reservoir of FIGS. 4-7.

FIG. 9 is an illustration of example data showing a comparison of calculated cumulative oil recovery using different models for the reservoir of FIGS. 4-8.

FIG. 10 is an illustration of example data showing a Y-function plot for a reservoir.

FIG. 11 is an illustration of example data showing field production and injection history for the reservoir of FIG. 10.

FIG. 12 is an illustration of example data showing a comparison of models with respect to normalized oil rate for the reservoir of FIGS. 10-11.

FIG. 13 is an illustration of example data showing a comparison of models with respect to cumulative oil recovery for the reservoir of FIGS. 10-12.

FIG. 14 is a diagram of an example computing system.

### DETAILED DESCRIPTION

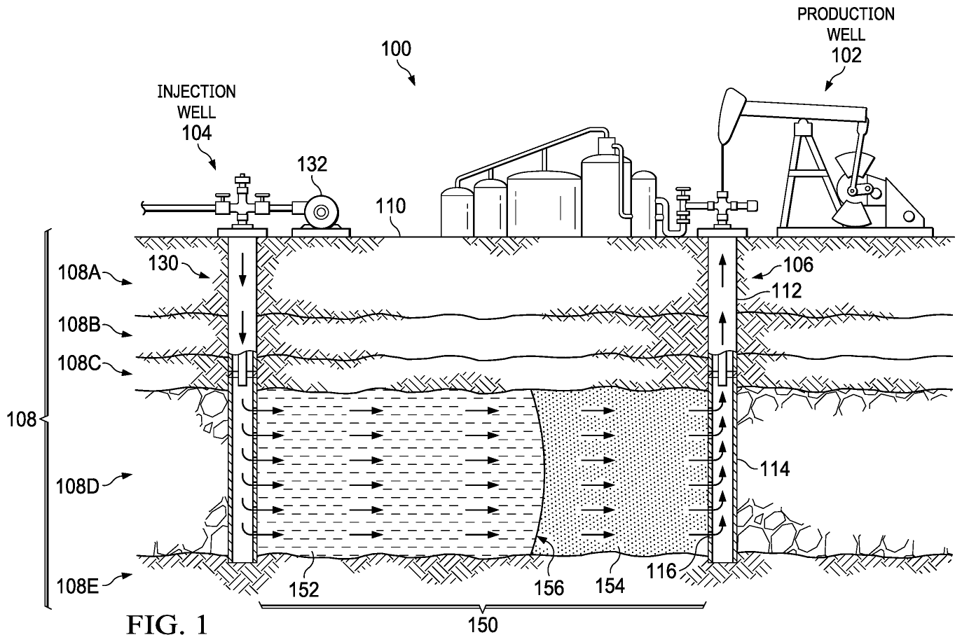

FIG. 1 is a schematic diagram of wellbore system 100 that includes a production well 102 and an injection well 104. The production well 102 includes a vertical wellbore 106 formed into a subterranean formation 108. In some examples, the wellbore 106 is formed by drilling into one or more layers of the subterranean formation 108. In this example, the wellbore 106 extends through four layers 108A-D and lands in subterranean layer 108E. In this example, a reservoir 150 of hydrocarbon 154 (e.g., oil) is located within subterranean layer 108D. The reservoir 150 includes porous shale rock with pores that contain the hydrocarbon 154 and/or sandstone with the hydrocarbon 154 located between the grains of the sandstone.

The production well 102 includes a production casing 114 formed downhole of a surface casing 112. In some examples, both the surface casing 112 and the production casing 114 are formed and set within the wellbore 106 by pouring cement between each respective casing 112, 114, and the subterranean layers 108A-E. The production casing 114 includes one or more perforations 116 that allow the hydrocarbon 152 to flow from the reservoir 150 into the wellbore 106 and up to the ground surface 110.

The injection well 104 includes a wellbore 130 that is the same as the wellbore 106 of the production well 102 except for the following differences. The injection well 104 includes a pump 132 that pumps a displacing fluid 152 (e.g., water) into the reservoir 150. In some examples, the injection of the fluid 152 increases a recovery of the hydrocarbon 154 from the reservoir 150 because the fluid 152 forces the hydrocarbon 154 through the porous shale and sandstone rock to the production well 102. The region where the fluid 152 and the hydrocarbon 154 interact is represented by region 156. In some examples, the process of injecting water 154 into the reservoir 150 for this purpose is referred to as “waterflooding.”

Eventually the amount of energy and time needed to recover the hydrocarbon 154 from the reservoir 150 becomes prohibitive. Oftentimes the recovery of any remaining hydrocarbon is abandoned at this point. This remaining hydrocarbon is referred to as “residual hydrocarbon.” In some examples, residual hydrocarbon is hydrocarbon 154 that is trapped within the pores of the shale and/or within the space of the grains of the sandstone.

The “residual oil saturation” (SOR) is another term of interest that is defined as the ratio of a volume of the residual hydrocarbon divided by the effective porosity of the rock (e.g., the shale or sandstone). A reservoir with a low residual oil saturation (e.g., less than 50%) is preferable over a reservoir with a high residual oil saturation (e.g., greater than 50%).

Determining the residual oil saturation of the reservoir 150 is important because the residual oil saturation indicates of how much hydrocarbon 154 is recoverable from the reservoir 150 when a particular displacing fluid 152 is used. However, determining the residual oil saturation is difficult because of a dependency on the particular displacing fluid, and in particular, a displacing velocity which represents the velocity of a wave-front of the hydrocarbon-fluid interface through the reservoir 150.

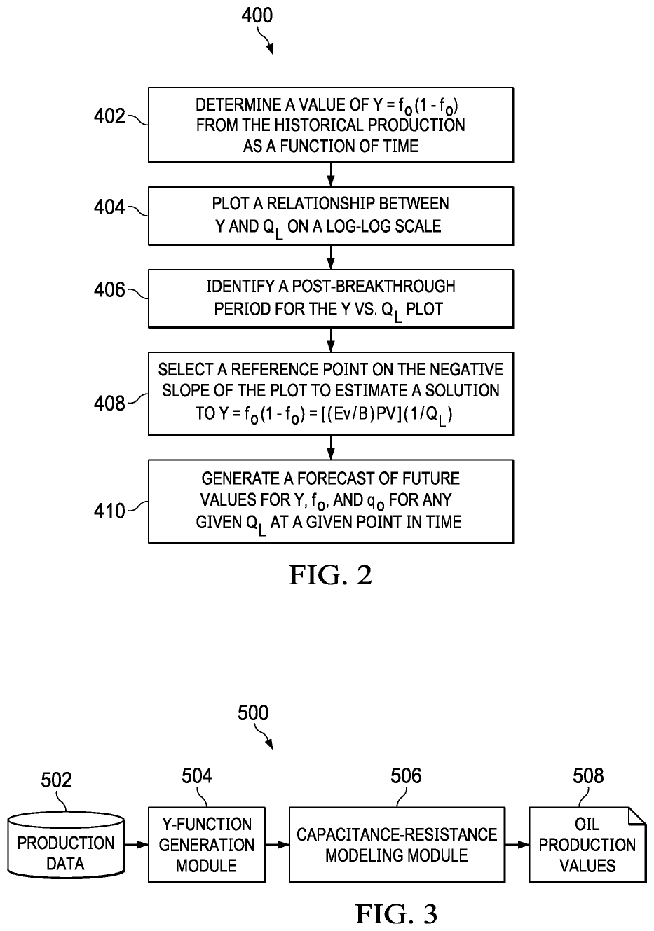

The data gathered by, for example, seismic surveys, well logging, and production data can be used as the basis for reservoir simulation, e.g., reservoir simulation performed for forecasting production performance during waterflooding a reservoir. This data provides the underlying basis for implementation of the systems and methods described with reference to FIGS. 2-14.

FIG. 2 is a flow diagram illustrating a process 400 for predicting production of hydrocarbons from a reservoir using analytical CRM models. As discussed previously, a data processing system (such as a data processing system 500 of FIG. 3, subsequently described) replaces an array of empirical models with a Y-function model for oil flow in the subterranean formation The data processing system determines a historical performance of production for injected water breakthrough timing. The data processing system determines various operational parameter values such as water channeling and an impact of pattern reconfiguration events like infill drilling, recompletion and other field redevelopment measures. The data processing system determines, from these data, a group parameter for oil production.

For using analytical CRM models, the data processing system executes oil-fractional flow functions for combining with the Y-function model as an analytical solution for waterfloods. The Y-function model is utilized to estimate the production of oil within the CRM model.

Generally, oil fractional flow models are classified into three types based on dependent variables. For example, Nₚ models are called cumulative oil production models. S_{w} models are called water saturation models. Equations 2 and 3 are water saturation models. Additionally, there are Wᵢ models, called cumulative water injection models. Cumulative oil production-based models are generally applied to extrapolate the amount of recoverable oil from the oil-cut. The variable Nₚ is generally unknown, and cannot be specified before calculating the oil-cut. For the saturation oil fractional models, due to the nature of the CRM not being a gridblock-based reservoir simulator, there are some consistency and availability issues. For example, oil fractional models generally use saturation information to calculate the recovery at the saturation level. When this data are not available, oil fractional models use an average value that does not precisely represent an actual value, available in gridblock-based numerical reservoir simulation models. The gridblock-based reservoir simulation models are not always practical and available due to a significant amount of data input required and the associated expense of data collection for acquiring saturation values from production data. The information on water saturation from production data is not generally available for calculating the oil rate from the liquid rate. To calculate an average water saturation, an overall material balance of water injection and oil/water production can be used, called average water saturation. In this approach, S_{w} represents the average water saturation between injectors and producers, rather than the producer-end saturation (S_{we}) used for displacement-based models such as the function of Equation 1. Equation 1 shows a relationship between the average saturation and producer-end saturation and water-cut (f_{we}) and cumulative injection (Wᵢ).

S̅_̅{̅w̅}̅=S_{we}+Wᵢ(1−f_{we}) (1)

The oil fractional flow functions are now described. The following oil fractional flow functions are executed by the data processing system to determine a production of oil within the CRM model. The production of oil is based on water saturation. Equations 2 and 3 are developed for viscous fingering description in miscible displacement.

$${f}_{S} ( S ) = \frac{K S}{1 + S ( K - 1 )} \qquad ( 2 )$$

$${f}_{S} ( S ) = \frac{1}{1 + ( \frac{1 - S}{S} ) ( \frac{1}{H} ) ( \frac{1}{E} )} \qquad ( 3 )$$

where K=H*E and where S is the solvent saturation (miscible displacement) or water saturation, when applied for immiscible waterflood. K is a parameter including both mobility ratio and formation heterogeneity.

The data processing system is configured to determine a production of oil from a degree of forecasted production of liquid. Models based on CRM use an empirical power law oil fractional flow model (EPLFFM) that follows an estimation of cumulative-water injection (Wᵢ). The EPLFFM is shown in Equation 4.

$${f}_{o} = \frac{1}{1 + {α ( {W}_{i} )}^{β}} \qquad ( 4 )$$

In a process, the data processing system is configured to assume a negligible capillary pressure effects in horizontal reservoirs. As shown in Equations 5 and 6, values for the ratio of mobility at the endpoint, Mₒ, and the curve for relative permeability m and n, are unknowns.

$${f}_{o} = 1 - {( 1 + \frac{{( 1 - S )}^{m}}{{M}_{o} {S}^{n}} )}^{- 1} \qquad ( 5 )$$

S is a normalized value of saturation of water defined in Equation 6.

$${S}_{w} ( t ) = \frac{{S}_{w} - {S}_{w i r}}{1 - {S}_{o r w} - {S}_{w i r}} \qquad ( 6 )$$

In a flooded section of the reservoir, a value of S changes depending on a degree of accumulation of water in the subsurface basin at each interval of production, shown in Equation 7.

S_{w}(tₖ)=S_{w}(tₖ₋₁)+[i(tₖ)−q_{w}(tₖ)/Vₚ]*Δtₖ (7)

In Equation 6, Vₚ is the value of the pore volume of the section that is flooded. To perform the forecast using the model of Equation 7, values for S_{wi}, or the irreducible water saturation, S_{orw} or the residual oil saturation, and Vₚ, along with exponents m and n are determined by the data processing system.

The oil fractional model of Equation 4 and the oil fractional model of Equation 1 receive as an input a value for water saturation. Because CRM is an empirical model, there is no grid definition for the producer data. The balance analysis for the saturation from overall injection or production volume of Equation 6 represents a saturation between injectors and producers rather than a saturation for the producer. The data processing system, to determine the oil fractional flow from producer data, receives as an input the saturation for the producer.

To overcome this technical limitation in which the input saturation data are not available or inconsistent (as previously described), the data processing system uses a Y-function model. The Y-function model is an analytical solution for waterfloods. The data processing system uses the Y-function model to estimate the production of oil within the CRM framework.

An analytical oil-cut model for the diagnosis and forecast of waterflood production performance is now described. For waterfloods with an unfavorable mobility ratio between water and oil, the data processing system applies the analytical model to either an individual reservoir or an offset group of reservoirs. The analytical model is generally applied after a volumetric sweep efficiency stabilizes in the unfavorable mobility waterflood displacement (M>1). The analytical model is shown in Equation 8.

$$Y = {f}_{o} ( 1 - {f}_{o} ) = ( \frac{{E}_{V}}{B} P V ) \frac{1}{{Q}_{L}} \qquad ( 8 )$$

wherein the value of fₒ is the fractional flow of oil, B is the constant value in the expression

$$( \frac{{k}_{r o}}{{k}_{r w}} = A {e}^{- B {S}_{w}} ) ,$$

wherein S_{w}, kᵣₒ and k_{rw} are values for water saturation, oil relative permeability, and the relative permeability of water, respectively. For the group of parameters, (E_{V}/B)PV, EV is the volumetric sweep efficiency, PV is the pore volume in barrels (bbl) found in the region, and Q_{L} serves as the cumulative liquid production (in bbl). B represents the ratio of oil relative permeability to water relative permeability. The data processing system determines values for this group of parameters by analysis of historical production performance. Determining the terms individually is generally unnecessary for the prediction of production performance as well as for surveillance application.

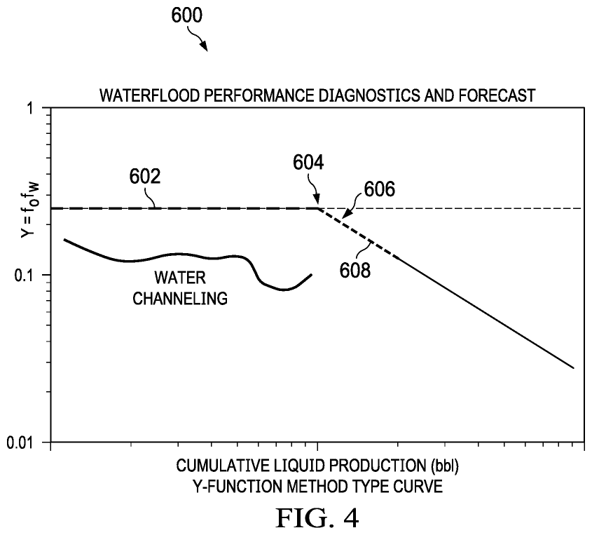

The Y model can be plotted on a log-log such as shown in graph 600 of FIG. 4. Equation 7 applies when there is an injected water breakthrough phase 604 for the producer. The oil saturation during the primary production period 602 only changes slightly, with the Y-function vs. Q_{L} for the period 602 immediately before the water breakthrough 604 showing an approximately flat straight line with a Y value slightly less than 0.5. The length of the primary production phase 602 flat line period depends on a contrast of initial and irreducible water saturations. The relationship is a direct relationship in which irreducible water saturation is the minimum interstitial water saturation. A breakthrough tends to occur earlier when initial water saturation is higher and especially higher than irreducible or critical water saturation. The contrast shown gives the degree of how much the initial water saturation different from the irreducible or critical water saturation in which subsurface water becomes mobile. This relationship of the effect of initial water saturation on the breakthrough condition is represented in Equation 9.

$$\frac{{f}_{WBT} - {F}_{w i}}{{S}_{w B T} - {S}_{w i}} = {( \frac{d {f}_{w}}{{dS}_{w}} )}_{BT} = {Bf}_{w B T} ( 1 - {f}_{w B T} ) \qquad ( 9 )$$

where fₒ is the oil fractional flow (fraction), f_{w} is the water fractional flow (fraction), and S is the saturation (fraction).

The data processing system can recognize the period immediately before a water breakthrough by finding the data signature corresponding to the primary production phase 602. The data processing system can determine a timing of injected water breakthrough by finding the data signature corresponding to the primary production phase 602. For predicting the rate of oil production before the water breakthrough, the data processing system uses either a traditional Arps/Fetkovich production decline model (using radial flow near a well bore), or a linear flow model for induced fracture.

A forecast by the data processing system for oil production with oil fractional flow is effective from a time of the injected water breakthrough 604. After this moment, and compared to the cumulative liquid production, the Y-function declines on the log-log graph 600 with a slope of −1, as shown in region 608 of graph 600. A significant deviation from either the Y value of 0.5 or the slope of −1 generally indicates abnormal water production issues, such as water channeling. The Y-function model of graph 600 can be used in various field applications such as production performance surveillance, diagnostics forecast and optimization, and diagnosing and quantifying water-channeling issues in waterfloods for assisting reservoir simulation studies.

The data processing system is configured to perform an estimation of the oil production rate using the Y-function model. Application scenarios are now described. The data processing system is configured to evaluate a group parameter (Ev/B)*PV. After an injected water breakthrough, the data processing system diagnoses the production performance using a straight line that has a slope of −1 and selects a reference point 606 of zero on the trend line of graph 600. The data processing system determines the group parameter (Ev/B)*PV based on Equation 10.

$$\frac{{E}_{V}}{B} P V = {[ {f}_{o} ( 1 - {f}_{o} ) {Q}_{L} ]}_{0} \qquad ( 10 )$$

The future Y-function Y=fₒ(1−fₒ) is forecast from future cumulative liquid Q_{L}, as shown in Equation (8). The data processing system estimates the value for future fractional oil flow, fₒ, and the rate of production of oil, qₒ, from the value of the future amount of liquid, q_{L}, as shown in Equations 11 and 12.

$${f}_{o} = \frac{1}{2} ( 1 - \sqrt{1 - 4 Y} ) \qquad ( 11 )$$

$${q}_{o} = {f}_{o} {q}_{L} \qquad ( 12 )$$

Q_{L} indicates a cumulative production value (by total volume) for liquid, which is q_{L} summed over time (q_{L}*time), where q_{L} is a rate (volume per unit time). The data processing system determines the oil rate from the whole production.

Returning to FIG. 2, the process 400 shows how the data processing system uses this Y-function model for forecasting, by the data processing system, the oil-fraction rates from the gross rate, as previously described. In some implementations, future hydrocarbon extraction can be performed based on the predictions of oil production. For example, if the predicted oil fraction exceeds a threshold, drilling of a well in the hydrocarbon reservoir can be performed based on the prediction of the future fractional oil flow and/or the future rate of production of oil from the hydrocarbon reservoir.

In some implementations, the process 400 is performed by the data processing system 500 of FIG. 3. For process 400, the data processing system is configured to determine (402) a value of Y=fₒ(1−fₒ) from the historical production as a function of time. The data processing system is configured to plot (404) Y vs. Q_{L} on a log-log scale. As previously described, this results in a graph such as graph 600 described in relation to FIG. 4. The data processing system is configured to identify (406) the post-breakthrough period for the Y vs. Q_{L} plot. This can correspond to period 608 of graph 600. The data processing system is configured to select (408) a reference point on the negative slope of the plot to estimate a solution to Equation 8. The reference point corresponds to example point 608 on the graph 600 as previously described. The data processing system is configured to generate (410) a forecast of future values for Y, fₒ, and qₒ for any given Q_{L} at a given point in time. The future values for Y, fₒ, and qₒ for a given Q_{L} are based on Equations 7, 10, and 11, described previously.

Once the data processing system determines values of Y, fₒ, and qₒ for any given Q_{L} at a given point in time, the data processing system can determine wettability values for the reservoir, including capillary forces in CRM. The data processing system uses CRM to determine wettability in the subsurface based on oil production rates and oil volumes. The data processing system introduces capillary forces to determine wettability by a contact angle method of wettability. In this study, we will not measure the contact angle instead we will calculate. This will eventually help reservoir simulation models needed for missing parameter of rock wettability in order to forecast the productivity of the oil field. As previously described, the f_{w} and fₒ parameters are used to evaluate recovery efficiency and for future production performance. The Y function is used to determine future production performance based on either f_{w} or fₒ, where f_{w} is fractional flow of water and equal to 1−fₒ, and fₒ is fractional flow of oil.

The CRM modeling using the Y function is now described. The value of capillary pressure is determined according to Equation 13.

$${P}_{c} = \frac{2 σ cos θ}{r} = \frac{2 σ cos θ}{\sqrt{\frac{k}{∅}}} \qquad ( 13 )$$

where P_{c} is capillary pressure, a is the interfacial tension, θ is the contact angle, k is the permeability, and Ø is the porosity. θ is set at values 0 to 180 at increments of 30 degrees. α=0 for horizontal flow. The capillary pressure is the pressure difference between two immiscible fluids interacting at the interface boundary. From the capillary pressure P_{c} the value of the fractional flow of water or oil is shown as Equation 14.

$${f}_{w} = \frac{1 + \frac{{k}_{o}}{{μ}_{o} {q}_{t}} [ \frac{2 σ cos θ}{L \sqrt{\frac{k}{∅}}} ]}{1 + \frac{{k}_{o}}{{k}_{w}} \frac{{μ}_{w}}{{μ}_{o}}} = 1 - {f}_{o} \qquad ( 14 )$$

The contact angle is determined using Equation 15.

$${Q}^{2} = ( \frac{2 {P}_{c} k ∅ {A}^{2} {S}_{w}}{{μ}_{w}} ) t \qquad ( 15 )$$

Q² versus t plot gives a slope, and then cos θ is obtained, as shown in Equation 16.

$$Slope = \frac{2 {P}_{c} k ∅ {A}^{2} {S}_{w}}{{μ}_{w}} \qquad ( 16 )$$

$$where {P}_{c} = \frac{2 σ cos θ}{r} = \frac{2 σ cos θ}{\sqrt{\frac{k}{∅}}} , and$$

where A is a cross sectional area of the region, Q is an oil volume value, t is a time, S is a saturation value, and μ_{w} is a value for water viscosity. The contact angle is used for direct measurement of wettability.

Measurement of the contact angle is typically conducted using the direct methods where the angle can visually be determined by examining a drop of a given liquid placed on polished mineral surfaces. As a result of mutual interactions of the interfaces formed between two immiscible fluids and a solid surface, a contact angle θ is established. The contact angle is usually measured towards a denser phase (such as water). For an oil-water-rock system, the approximate relationship can be established between the wettability and the contact angle. The system is said to be water-wet if the contact angle is between 0° and 60°-75°, and the system is defined as oil-wet if the contact angle is between 180° and 105° to 120°. In some implementations, the data processing system first assigns variable contact angle values changing from 0° to 180° (such as at 30° increments) in order calculate recovery efficiency and production performance based on in each contact angle. The data processing system generates a prediction of a recovery efficiency or future production performance (or both) if the contact angle is known. In some implementations, the data processing system determines the value of the contact angle with a given production history. The data processing system then generates a prediction of the recovery efficiency or future production performance (or both).

The data processing system, when using the Y-function of process 400, provides an improved degree of oil rate prediction relative to cumulative oil production models and water saturation models. In the following examples, cumulative oil comparison and oil rate deviation are used from actual field oil rates.

In some implementations, cumulative oil production may not be available. When this is the case, the Y-Function comes out to be a better choice to use for predicting oil rates within CRM methods in comparison with empirical approaches described previously. In an example, an improvement of at least 2-10% may be realized, which results in large volume differences in many fields. Further, in addition to providing a better forecast of oil rates or oil cuts, the Y-function is applicable to unfavorable waterfloods, and can diagnose operational issues in a waterflood with extreme water channeling. As seen in Table 1, the Y-Function used in process 400 compares favorably with other methods described herein.

TABLE 1
Comparison of average error (%) on cumulative oil
recovery and variance for oil rate prediction.

| | | BLBFFM | | EPLFFM |
|---|---|---|---|---|
| | | (8.4, 1.6, | BLBFFM | (6.69E−09, |
| | Y | 2.6) | (6.8, 1, 1) | 1.631) |
| Avg. Error | −2.40% | −9.32% | −5.92% | 0.38% |
| Avg. Variance | 0.0827 | 0.325 | 0.242 | 0.302 |

Table 1 shows a comparison of average error percentage on cumulative oil recovery and variance for oil rate prediction using the Y-Function process and other methods for a given reservoir (e.g., the Reinecke Reservoir). The Y-function provides a lower variance than the EPLFFM approach and predictions can be performed at different contact angles. Numbers near the model names represent fitting parameters, where alpha and beta are the fitting parameters for the empirical power-law, fractional-flow model (EPLFFM), which is designated by EPLFFM(alpha, beta). The second model is a fractional-flow model by neglecting capillary pressure for horizontal reservoirs, shown in Equation 17.

$${f}_{o} ( t ) = \frac{1}{1 + α {W}_{i}^{β}} \qquad ( 17 )$$

where Wᵢ is the cumulative water injected. The endpoint mobility ratio, Mₒ, and relative permeability curve exponents, m and n, are the unknowns in the Buckley-Leverett-based fractional-flow model (BLBFFM), designated by BLBFFM(Mₒ, m, n) in Equation 18.

$${f}_{o} ( S ) = 1 - {[ 1 + \frac{{( 1 - S )}^{m}}{{M}_{o} {S}^{n}} ]}^{- 1} \qquad ( 18 )$$

Table 2 shows example values for a generated Y-Function.

TABLE 2
Example Y-Function Values.

| Q_{L} | Y | Q_{L} | Y | | |
|---|---|---|---|---|---|
| reading | reading | reading | reading | (E_{V}/B)PV | (E_{V}/B)PV |
| period 1 | period 1 | period 2 | period 2 | period 1 | period 2 |
| 255.59 | 0.180 | 404.9 | 0.0807 | 46.0 | 32.6 |

TABLE 3
Comparison of average error (%) on cumulative oil
recovery and variance for oil rate prediction.

| | Y | EPLFFM |
|---|---|---|
| Avg. Error | −2.6914% | −5.0481% |
| Avg. Variance | 0.0757 | 0.0716 |

Table 2 shows example values of a Y-Function that are used, such as for the Reinecke Reservoir. The values shown can be used for performing the process 400 of FIG. 2 when determining production values for the Reinecke Reservoir. As previously discussed, this is an illustrative example that is further described in relation FIGS. 4-9.

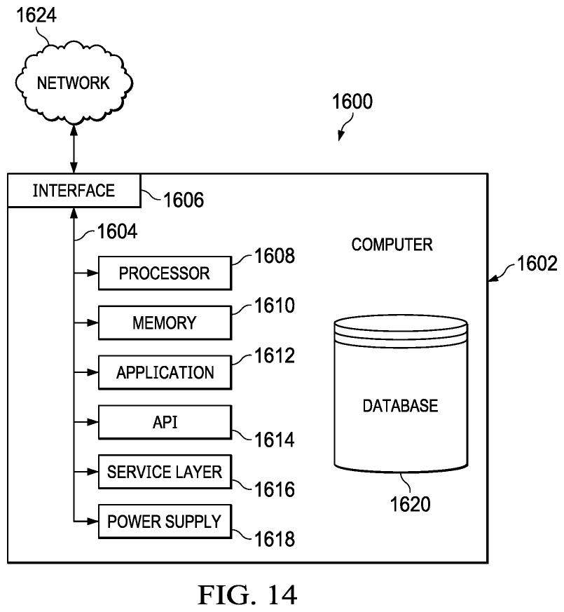

FIG. 3 shows an example data processing system 500 for predicting production of hydrocarbons from a reservoir using analytical CRM models. The data processing system 500 can include the data processing system previously described for executing the logic for process 400 described in relation to FIG. 2. In some implementations, the data processing system 500 includes a computing system as described in relation to FIG. 14.

As described previously, the data processing system 500 obtains production data 502. The production data can include historical oil production for the region or reservoir. The data processing system 500 uses the Y-Function generation module 504 to generate the Y-function as previously described. The reference point of the Y-function is used during CRM modeling by the CRM module 506 to generate oil production forecast values 508.

FIG. 4 shows an example graph 600 of a Y-function for predicting production of hydrocarbons from a reservoir. The graph 600 is a log-log plot. The Y-function includes a primary production period 602 in which the value of Y is unchanged for various cumulative liquid production values (in barrels). A reference point 606 is determined at where the graph 600 has a negative slope (e.g., −1). The waterflood history trend and forecast region 608 are at where the slope is −1. The reference point 606 is near the injected water breakthrough point 604, as described previously.

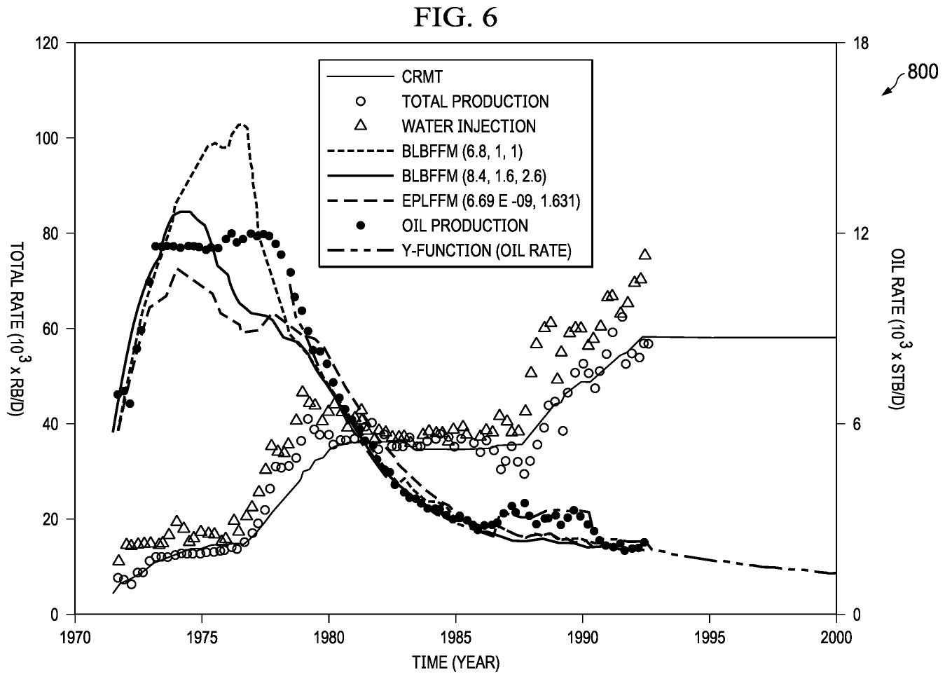

FIG. 6 is a graph 700 illustrating an example of data showing a production history from the reservoir associated with the Y-function graph 600 of FIG. 4. The graph 700 shows example values for q_{w}, q_{L}, and qₒ over time for the Reinecke Reservoir.

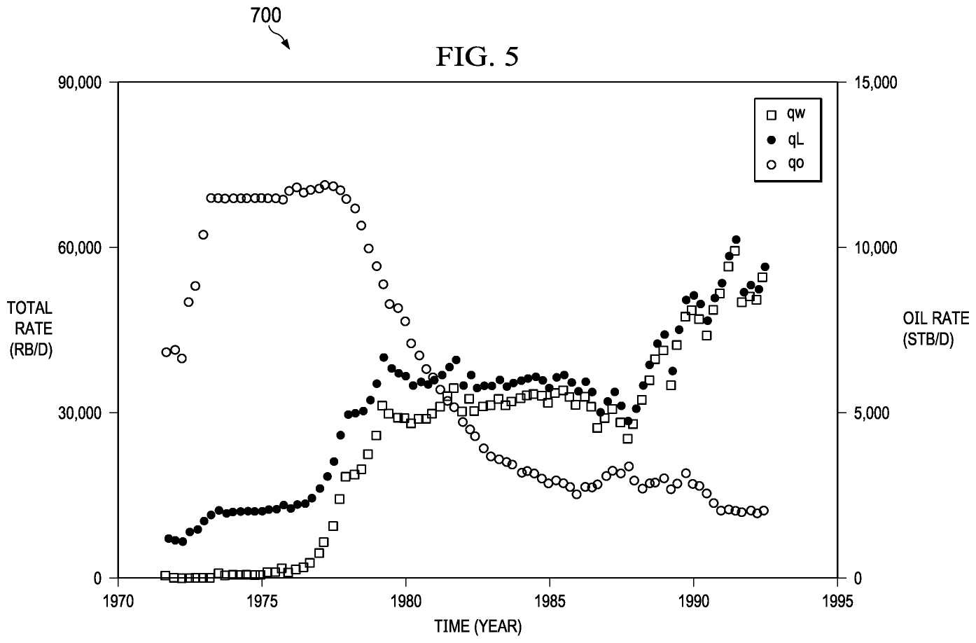

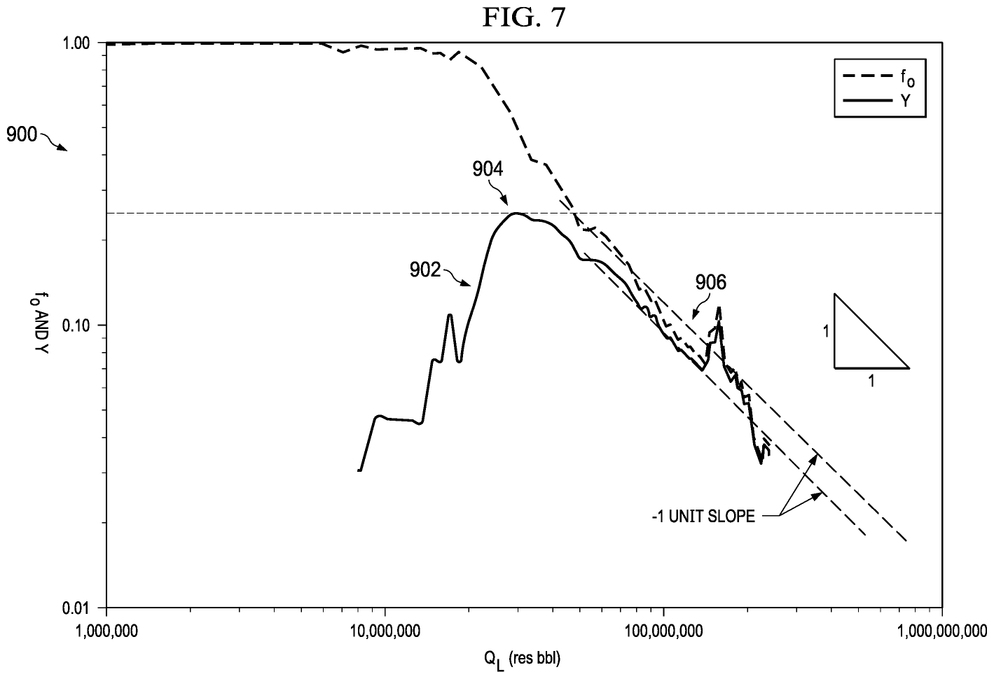

FIG. 7 is a graph 800 including example data showing a comparison of oil-rate predictions from the reservoir of FIGS. 4-5 over a time period. This applies the Y-function method described previously using field data shown in FIGS. 4-5.

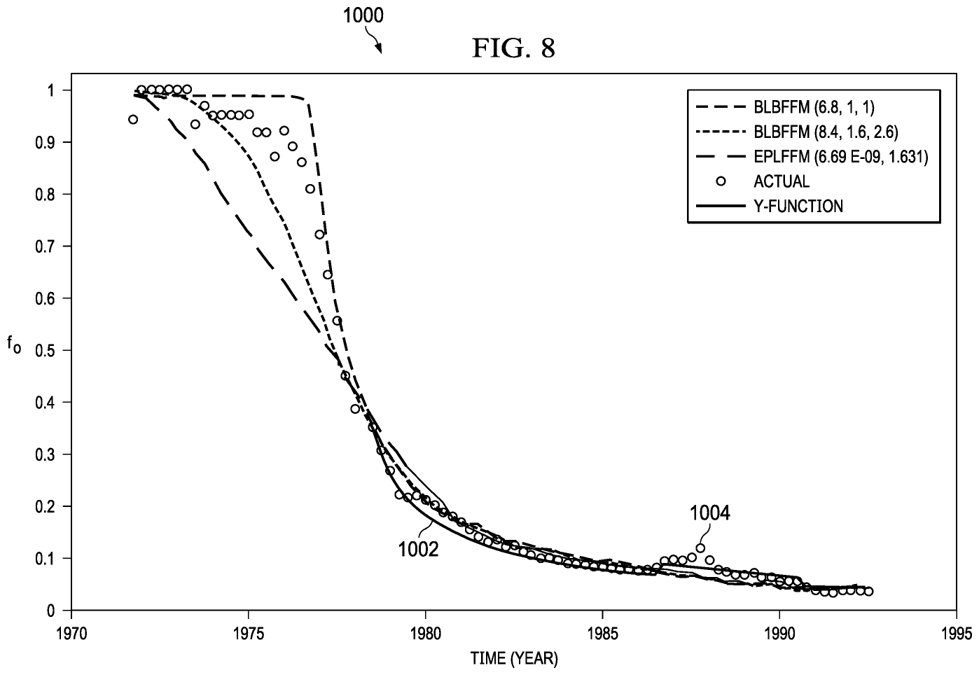

FIG. 8 is a graph 900 of example data showing production performance diagnosis by the Y-function method for the reservoir associated with the graphs 600, 700, and 800 of FIGS. 2-4. The graph 900 shows a Y-function that shows a primary production phase 902, an injected water breakthrough 904, and a waterflood trend phase 906. The Y-function of graph 900 can be used to predict oil production for the reservoir associated with graphs 600, 700, and 800 as previously described.

FIG. 8 is a graph 1000 showing example data of an oil-cut calculation comparison for the reservoir of FIGS. 4-7. As shown in graph 1000, the Y-function-based prediction trend line 1002 closely tracks the realized production values 1004.

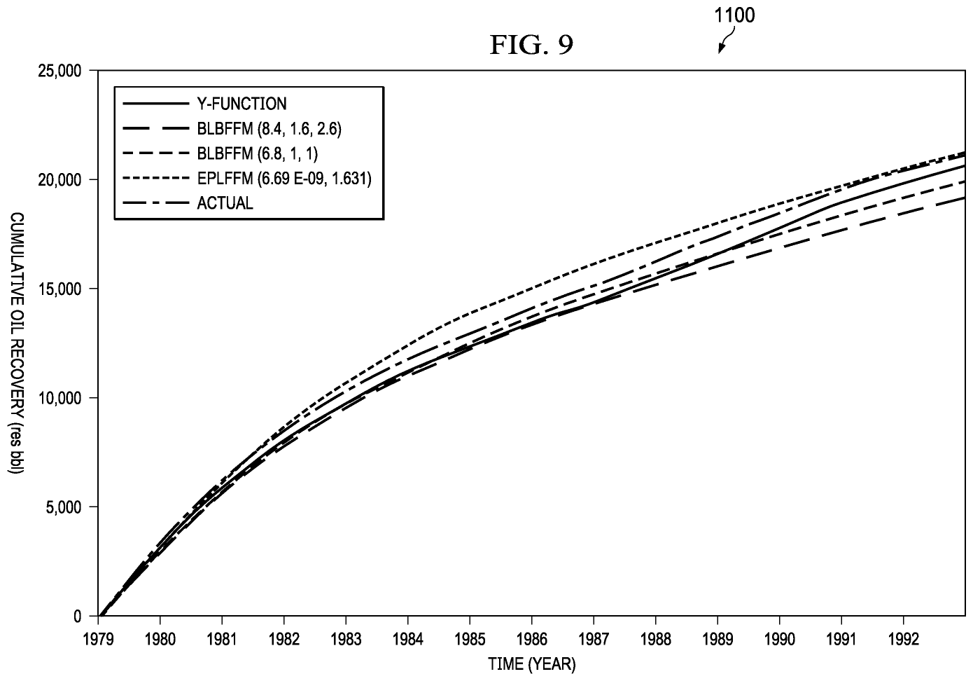

FIG. 9 is a graph 1100 showing a comparison of calculated cumulative oil recovery using different models for the reservoir of FIGS. 4-8.

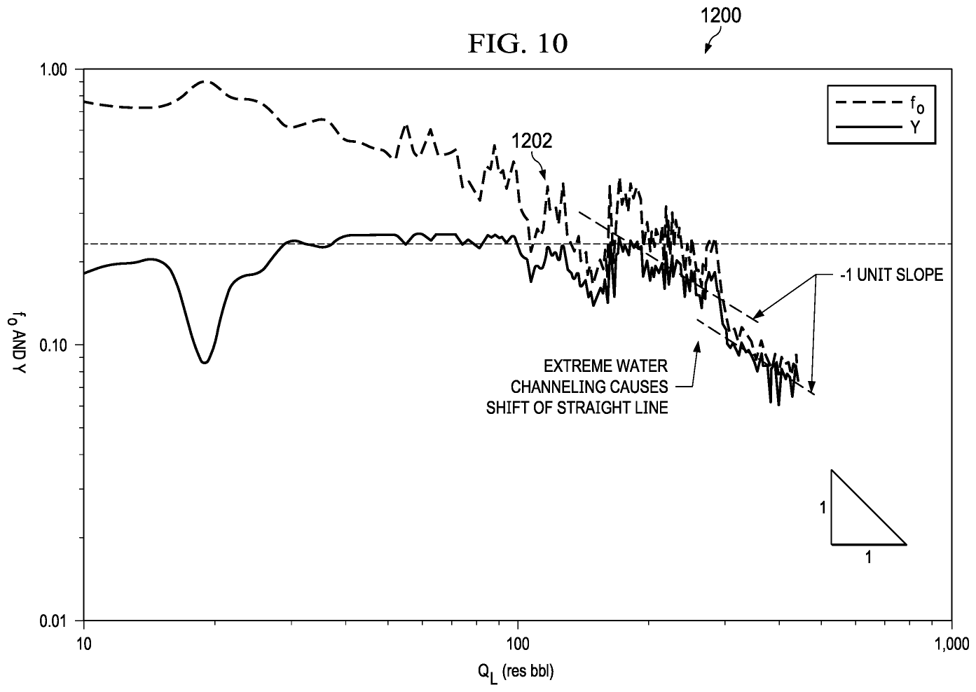

FIG. 10 is a graph 1200 showing a Y-function plot for a reservoir. After the injected water breakthrough point 1202, the fractional flow of oil fₒ tracks the Y-function slope of −1 on the log-log graph 1200. Water channeling causes a discontinuity of the function in which the fraction oil flow suddenly drops with respect to Q_{L}.

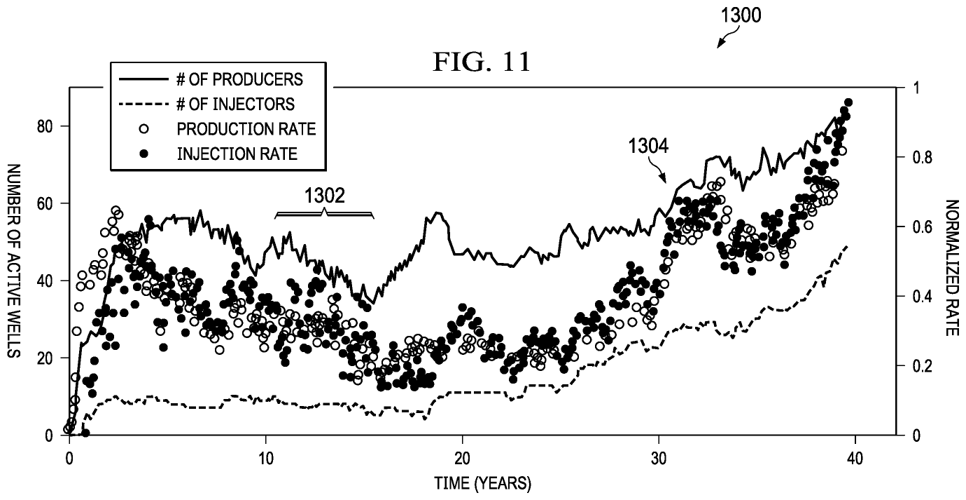

FIG. 11 is a graph 1300 showing field production and injection history for the reservoir associated with of FIG. 10. In a first period 1302, a sudden increase in a number of active wells in the reservoir with a maintained injection rate causes sever water channeling. In a second period 1304, a sudden increase in injection rate and water-channeling causes a shift in the Y-function analysis, as described in relation to FIG. 10.

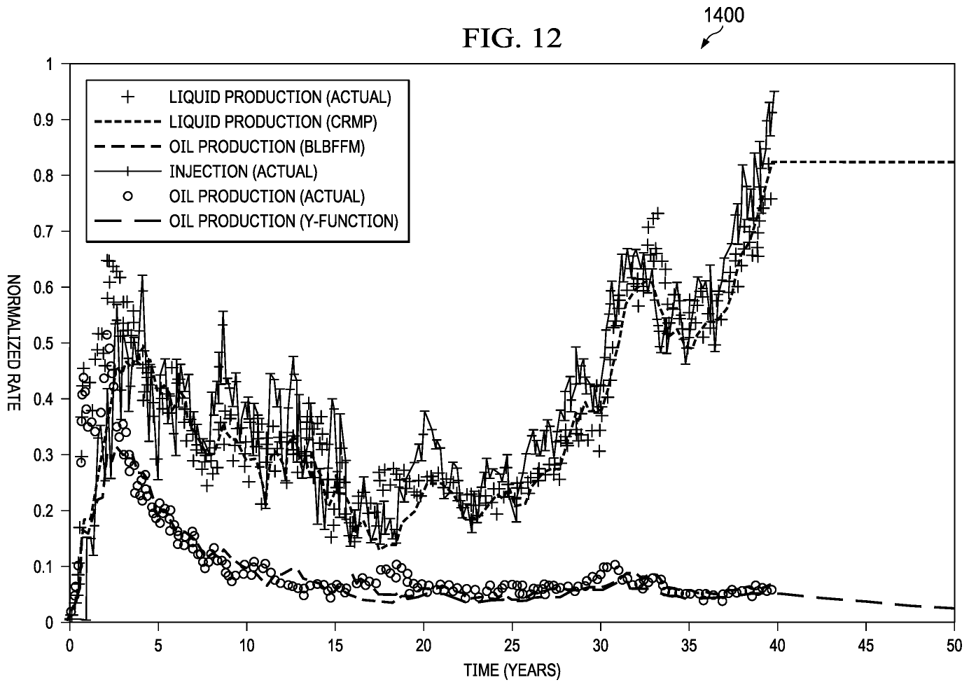

FIG. 12 is a graph 1400 showing a comparison of models with respect to normalized oil rate for the reservoir of FIGS. 10-11. The actual oil production rate tracks the Y-function prediction.

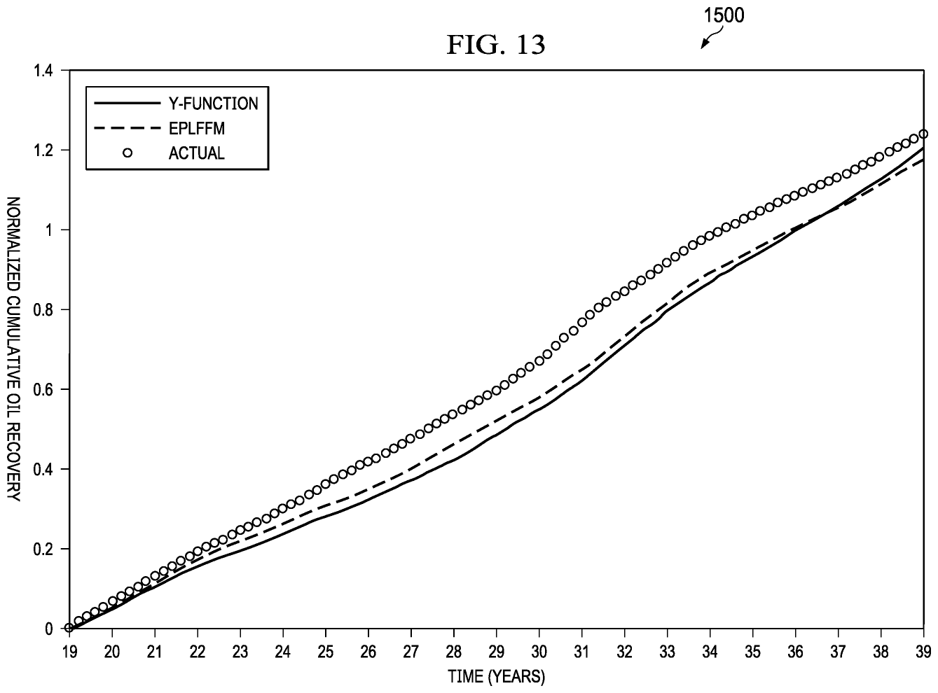

FIG. 13 is a graph 1500 showing a comparison of models with respect to cumulative oil recovery for the reservoir of FIGS. 10-12. The variance of the EPLFFM is larger than that of the Y-function, which is also easier to calculate, needing less data as described previously.

FIG. 14 is a block diagram of an example computing system 1600 used to provide computational functionalities associated with described algorithms, methods, functions, processes, flows, and procedures described in the present disclosure, according to some implementations of the present disclosure. The illustrated computer 1602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1602 can include input devices such as keypads, keyboards, and touch screens that can accept user information. Also, the computer 1602 can include output devices that can convey information associated with the operation of the computer 1602. The information can include digital data, visual data, audio information, or a combination of information. The information can be presented in a graphical user interface (UI) (or GUI).

The computer 1602 can serve in a role as a client, a network component, a server, a database, a persistency, or components of a computer system for performing the subject matter described in the present disclosure. The illustrated computer 1602 is communicably coupled with a network 1624. In some implementations, one or more components of the computer 1602 can be configured to operate within different environments, including cloud-computing-based environments, local environments, global environments, and combinations of environments.

At a high level, the computer 1602 is an electronic computing device operable to receive, transmit, process, store, and manage data and information associated with the described subject matter. According to some implementations, the computer 1602 can also include, or be communicably coupled with, an application server, an email server, a web server, a caching server, a streaming data server, or a combination of servers.

The computer 1602 can receive requests over network 1624 from a client application (for example, executing on another computer 1602). The computer 1602 can respond to the received requests by processing the received requests using software applications. Requests can also be sent to the computer 1602 from internal users (for example, from a command console), external (or third) parties, automated applications, entities, individuals, systems, and computers.

Each of the components of the computer 1602 can communicate using a system bus 1604. In some implementations, any or all of the components of the computer 1602, including hardware or software components, can interface with each other or the interface 1606 (or a combination of both), over the system bus 1604. Interfaces can use an application programming interface (API) 1614, a service layer 1616, or a combination of the API 1614 and service layer 1616. The API 1614 can include specifications for routines, data structures, and object classes. The API 1614 can be either computer-language independent or dependent. The API 1614 can refer to a complete interface, a single function, or a set of APIs.

The service layer 1616 can provide software services to the computer 1602 and other components (whether illustrated or not) that are communicably coupled to the computer 1602. The functionality of the computer 1602 can be accessible for all service consumers using this service layer. Software services, such as those provided by the service layer 1616, can provide reusable, defined functionalities through a defined interface. For example, the interface can be software written in JAVA, C++, or a language providing data in extensible markup language (XML) format. While illustrated as an integrated component of the computer 1602, in alternative implementations, the API 1614 or the service layer 1616 can be stand-alone components in relation to other components of the computer 1602 and other components communicably coupled to the computer 1602. Moreover, any or all parts of the API 1614 or the service layer 1616 can be implemented as child or sub-modules of another software module, enterprise application, or hardware module without departing from the scope of the present disclosure.

The computer 1602 includes an interface 1606. Although illustrated as a single interface 1606 in FIG. 14, two or more interfaces 1606 can be used according to particular needs, desires, or particular implementations of the computer 1602 and the described functionality. The interface 1606 can be used by the computer 1602 for communicating with other systems that are connected to the network 1624 (whether illustrated or not) in a distributed environment. Generally, the interface 1606 can include, or be implemented using, logic encoded in software or hardware (or a combination of software and hardware) operable to communicate with the network 1624. More specifically, the interface 1606 can include software supporting one or more communication protocols associated with communications. As such, the network 1624 or the hardware of the interface can be operable to communicate physical signals within and outside of the illustrated computer 1602.

The computer 1602 includes a processor 1608. Although illustrated as a single processor 1608 in FIG. 14, two or more processors 1608 can be used according to particular needs, desires, or particular implementations of the computer 1602 and the described functionality. Generally, the processor 1608 can execute instructions and can manipulate data to perform the operations of the computer 1602, including operations using algorithms, methods, functions, processes, flows, and procedures as described in the present disclosure.

The computer 1602 also includes a database 1620 that can hold data for the computer 1602 and other components connected to the network 1624 (whether illustrated or not). For example, database 1620 can be an in-memory, conventional, or a database storing data consistent with the present disclosure. In some implementations, database 1620 can be a combination of two or more different database types (for example, hybrid in-memory and conventional databases) according to particular needs, desires, or particular implementations of the computer 1602 and the described functionality. Although illustrated as a single database 1620 in FIG. 14, two or more databases (of the same, different, or combination of types) can be used according to particular needs, desires, or particular implementations of the computer 1602 and the described functionality. While database 1620 is illustrated as an internal component of the computer 1602, in alternative implementations, database 1620 can be external to the computer 1602.

The computer 1602 also includes a memory 1610 that can hold data for the computer 1602 or a combination of components connected to the network 1624 (whether illustrated or not). Memory 1610 can store any data consistent with the present disclosure. In some implementations, memory 1610 can be a combination of two or more different types of memory (for example, a combination of semiconductor and magnetic storage) according to particular needs, desires, or particular implementations of the computer 1602 and the described functionality. Although illustrated as a single memory 1610 in FIG. 14, two or more memories 1610 (of the same, different, or combination of types) can be used according to particular needs, desires, or particular implementations of the computer 1602 and the described functionality. While memory 1610 is illustrated as an internal component of the computer 1602, in alternative implementations, memory 1610 can be external to the computer 1602.

The application 1612 can be an algorithmic software engine providing functionality according to particular needs, desires, or particular implementations of the computer 1602 and the described functionality. For example, application 1612 can serve as one or more components, modules, or applications. Further, although illustrated as a single application 1612, the application 1612 can be implemented as multiple applications 1612 on the computer 1602. In addition, although illustrated as internal to the computer 1602, in alternative implementations, the application 1612 can be external to the computer 1602.

The computer 1602 can also include a power supply 1618. The power supply 1618 can include a rechargeable or non-rechargeable battery that can be configured to be either user- or non-user-replaceable. In some implementations, the power supply 1618 can include power-conversion and management circuits, including recharging, standby, and power management functionalities. In some implementations, the power-supply 1618 can include a power plug to allow the computer 1602 to be plugged into a wall socket or a power source to, for example, power the computer 1602 or recharge a rechargeable battery.

There can be any number of computers 1602 associated with, or external to, a computer system containing computer 1602, with each computer 1602 communicating over network 1624. Further, the terms “client,” “user,” and other appropriate terminology can be used interchangeably, as appropriate, without departing from the scope of the present disclosure. Moreover, the present disclosure contemplates that many users can use one computer 1602 and one user can use multiple computers 1602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 402.11 a/b/g/n or 402.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, it will be understood that various modifications may be made without departing from the spirit and scope of the data processing system described herein. Accordingly, other embodiments are within the scope of the following claims.

What is claimed is:

1. A method for predicting oil production from a reservoir, the method comprising:
obtaining production data from a hydrocarbon reservoir, the production data comprising data representing a fractional oil flow;
determining, based on the production data, a relationship between the fractional oil flow and cumulative liquid production;
identifying, based on the relationship between the fractional oil flow and cumulative liquid production, a post-water breakthrough point;
estimating a value for a group parameter at a reference point of the relationship occurring after the post-water breakthrough point; and
based on the value of the group parameter, generating a prediction of a future fractional oil flow and a future rate of production of oil from the hydrocarbon reservoir.

2. The method of claim 1, wherein the production data comprises values for at least one of pore volume of the hydrocarbon reservoir and a volumetric sweep efficiency of the hydrocarbon reservoir.

3. The method of claim 1, wherein the relationship between the fractional oil flow and cumulative liquid production comprises an analytical equation
$$Y = {f}_{o} ( 1 - {f}_{o} ) = ( \frac{{E}_{V}}{B} P V ) \frac{1}{{Q}_{L}} ,$$
wherein Y is the relationship, fₒ is the fractional oil flow, Eᵥ is a value of volumetric sweep efficiency for the hydrocarbon reservoir, PV is a value of a pore volume of the hydrocarbon reservoir, B is a ratio of a relative permeability of oil to a relative permeability of water, and Q_{L} is a value of the cumulative liquid production in the hydrocarbon reservoir.

4. The method of claim 1, wherein estimating a value for a group parameter (Ev/B)*PV at a reference point of the relationship comprises determining the value for the group parameter by setting Y=fₒ (1−fₒ)=0, wherein Y is the relationship, fₒ is the fractional oil flow, Eᵥ is a value of volumetric sweep efficiency for the hydrocarbon reservoir, PV is a value of a pore volume of the hydrocarbon reservoir, B is a ratio of a relative permeability of oil to a relative permeability of water.

5. The method of claim 1, further comprising:
drilling a well in the hydrocarbon reservoir based on the prediction of the future fractional oil flow or the future rate of production of oil from the hydrocarbon reservoir.

6. The method of claim 1, wherein generating the prediction of a future fractional oil flow and a future rate of production of oil from the hydrocarbon reservoir comprises applying a capacitance-resistance model (CRM) to the relationship between the fractional oil flow and cumulative liquid production, the CRM configured to determine a value for a capillary pressure based on the predicted fractional flow of oil.

7. A system for predicting oil production from a reservoir, the system comprising:
at least one processor; and
a memory storing instructions that, when executed by the at least one processor, cause the at least one processor to perform operations comprising:
obtaining production data from a hydrocarbon reservoir, the production data comprising data representing a fractional oil flow;
determining, based on the production data, a relationship between the fractional oil flow and cumulative liquid production;
identifying, based on the relationship between the fractional oil flow and cumulative liquid production, a post-water breakthrough point;
estimating a value for a group parameter at a reference point of the relationship occurring after the post-water breakthrough point; and
based on the value of the group parameter, generating a prediction of a future fractional oil flow and a future rate of production of oil from the hydrocarbon reservoir.

8. The system of claim 7, wherein the production data comprises values for at least one of pore volume of the hydrocarbon reservoir and a volumetric sweep efficiency of the hydrocarbon reservoir.

9. The system of claim 7, wherein the relationship between the fractional oil flow and cumulative liquid production comprises an analytical equation
$$Y = {f}_{o} ( 1 - {f}_{o} ) = ( \frac{{E}_{V}}{B} P V ) \frac{1}{{Q}_{L}} ,$$
wherein Y is the relationship, fₒ is the fractional oil flow, Eᵥ is a value of volumetric sweep efficiency for the hydrocarbon reservoir, PV is a value of a pore volume of the hydrocarbon reservoir, B is a ratio of a relative permeability of oil to a relative permeability of water, and Q_{L} is a value of the cumulative liquid production in the hydrocarbon reservoir.

10. The system of claim 7, wherein estimating a value for a group parameter (Ev/B)*PV at a reference point of the relationship comprises determining the value for the group parameter by setting Y=fₒ (1−fₒ)=0, wherein Y is the relationship, fₒ is the fractional oil flow, Eᵥ is a value of volumetric sweep efficiency for the hydrocarbon reservoir, PV is a value of a pore volume of the hydrocarbon reservoir, B is a ratio of a relative permeability of oil to a relative permeability of water.

11. The system of claim 7, the operations further comprising:
drilling a well in the hydrocarbon reservoir based on the prediction of the future fractional oil flow or the future rate of production of oil from the hydrocarbon reservoir.

12. The system of claim 7, wherein generating the prediction of a future fractional oil flow and a future rate of production of oil from the hydrocarbon reservoir comprises applying a capacitance-resistance model (CRM) to the relationship between the fractional oil flow and cumulative liquid production, the CRM configured to determine a value for a capillary pressure based on the predicted fractional flow of oil.

13. One or more non-transitory computer readable media storing instructions for predicting oil production from a reservoir, the instructions, when executed by at least one processor, configured to cause the at least one processor to perform operations comprising:
obtaining production data from a hydrocarbon reservoir, the production data comprising data representing a fractional oil flow;
determining, based on the production data, a relationship between the fractional oil flow and cumulative liquid production;
identifying, based on the relationship between the fractional oil flow and cumulative liquid production, a post-water breakthrough point;
estimating a value for a group parameter at a reference point of the relationship occurring after the post-water breakthrough point; and
based on the value of the group parameter, generating a prediction of a future fractional oil flow and a future rate of production of oil from the hydrocarbon reservoir.

14. The one or more non-transitory computer readable media claim 13, wherein the production data comprises values for at least one of pore volume of the hydrocarbon reservoir and a volumetric sweep efficiency of the hydrocarbon reservoir.

15. The one or more non-transitory computer readable media claim 13, wherein the relationship between the fractional oil flow and cumulative liquid production comprises an analytical equation
$$Y = {f}_{o} ( 1 - {f}_{o} ) = ( \frac{{E}_{V}}{B} P V ) \frac{1}{{Q}_{L}} ,$$
wherein Y is the relationship, fₒ is the fractional oil flow, Eᵥ is a value of volumetric sweep efficiency for the hydrocarbon reservoir, PV is a value of a pore volume of the hydrocarbon reservoir, B is a ratio of a relative permeability of oil to a relative permeability of water, and Q_{L} is a value of the cumulative liquid production in the hydrocarbon reservoir.

16. The one or more non-transitory computer readable media claim 13, wherein estimating a value for a group parameter (Ev/B)*PV at a reference point of the relationship comprises determining the value for the group parameter by setting Y=fₒ (1−fₒ)=0, wherein Y is the relationship, fₒ is the fractional oil flow, Eᵥ is a value of volumetric sweep efficiency for the hydrocarbon reservoir, PV is a value of a pore volume of the hydrocarbon reservoir, B is a ratio of a relative permeability of oil to a relative permeability of water.

17. The one or more non-transitory computer readable media claim 13, the operations further comprising:
drilling a well in the hydrocarbon reservoir based on the prediction of the future fractional oil flow or the future rate of production of oil from the hydrocarbon reservoir.

18. The one or more non-transitory computer readable media claim 13, wherein generating the prediction of a future fractional oil flow and a future rate of production of oil from the hydrocarbon reservoir comprises applying a capacitance-resistance model (CRM) to the relationship between the fractional oil flow and cumulative liquid production, the CRM configured to determine a value for a capillary pressure based on the predicted fractional flow of oil.
